(19) United States
(12) Patent Application Publication
(10) Pub. No.: US 2010/0077128 A1
(43) Pub. Date: Mar. 25, 2010

(54) MEMORY MANAGEMENT IN A VIRTUAL MACHINE BASED ON PAGE FAULT PERFORMANCE WORKLOAD CRITERIA

(75) Inventors: Kevin S. Stansell, Raleigh, NC (US); Edward V. Zorek, SR., Cary, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/234,850

(22) Filed: Sep. 22, 2008

(51) Int. Cl. G06F 12/08; G06F 9/455

(52) U.S. Cl. 711/6; 718/1; 711/E12.059; 711/E12.017

(57) ABSTRACT

Embodiments of the present invention address deficiencies of the art in respect to virtualization and provide a novel and non-obvious method, system and computer program product for monitoring and managing memory used in a virtualized computing environment. In this regard, a method for monitoring and managing memory used by a virtual machine in a virtualized computing environment can include counting page fault occurrences in a guest operating system (OS) executing in the VM, pinning additional physical memory to the VM along with initiating a hot-add event to the guest OS executing in the VM, responsive to exceeding a page fault allowance threshold in order to mitigate system degradation in the VM based on page fault occurrences.

### BACKGROUND OF THE INVENTION

1. Field of the Invention

The present invention relates to the field of virtualization and more particularly to memory management of operating systems executing in virtualized computing environments.

2. Description of the Related Art

As processor power increased exponentially throughout the years, advanced forms of operating systems (OS) enabled both simulated and actual multi-tasking such that multiple applications could execute within the same host computing environment. Most applications have become co-dependent on the presence of other applications such that the requisite environment for an application includes not only the underlying operating system and supporting hardware platform, but also other key applications including application servers, database management servers, collaboration servers and communicative logic commonly referred to as middleware.

Recently, virtualization has been able to offer the inherent advantage of environment portability. Further, more powerful computing environments can support the coexistence of multiple different virtual machine (VM) images, all the while maintaining a virtual separation between the VM images. Consequently, a failure condition in one VM image cannot jeopardize the integrity of other co-executing VM images in the same hardware platform.

In a virtualized environment, a virtual machine monitor/manager (VMM) is the primary resource manager, capable of managing the interaction between each VM image and the underlying resources provided by the hardware platform. The VMM, also known as the hypervisor, can support the operation of different “guest operating system images”—known as VM images—the number of VM images being limited only by the processing resources of a VM container holding the VM images or the hardware platform itself.

The hypervisor typically manages the resources of CPU, memory and storage. There are two main categories of memory regarding a VM image, virtual memory and physical memory. Virtual memory can be greater than physical memory. Typically, a guest OS running in a VM manages pages internally in a page table in its virtual memory. While processing memory, if a request is made for a memory page that is not currently within the set of pages visible to the process in memory, an event known as a “page fault” occurs when a program accesses a page that is mapped in address space, but not loaded in physical memory. Since a page fault is essentially an interrupt (or exception) to the software raised by the hardware, page faults in a VM can cause significant performance penalties that disadvantage the base resource consolidation benefit inherent in virtualization for enterprise production environments.

Large resource rich systems meant for virtualization of production environments are more efficient when VM virtual memory does not exceed the physical memory attributed to that VM and the physical memory is additionally pinned to the specific VM. VM memory performance can be near optimal when virtual memory is equivalent to pinned (allocated) physical memory and the amount of virtual memory is sufficient to avoid paging outside the VM scope.

For instance, when an operating system starts to run out of memory, it will start to page fault and typically on a bare metal system end up paging out to disk. Nevertheless, inside a VM that disk is virtual and could be either a physical system entity managed by the hypervisor or merely a large memory buffer managed by the hypervisor. Yet, the drawback still remains that paging will end up degrading the system even as the hypervisor attempts to manage page faults. In most cases the amount of memory allocated to a VM is generally static during runtime of the VM. Some hypervisors have the capability to manually add or remove memory runtime to the VM if the OS running in the VM has hot-add capability. While a hot-add event could be purely virtual, such a hot-add event does not address the large performance penalty due to page faulting and actually contributes to the degradation and therefore is of minimal interest.

### BRIEF SUMMARY OF THE INVENTION

Embodiments of the present invention address deficiencies of the art in respect to virtualization and provide a novel and non-obvious method, system and computer program product for monitoring and managing memory used in a virtualized computing environment. In this regard, a method for monitoring and managing memory used by a virtual machine in a virtualized computing environment can include counting page fault occurrences in a guest operating system (OS) executing in the VM, pinning additional physical memory to the VM along with initiating a hot-add event to the guest OS executing in the VM, responsive to exceeding a page fault allowance threshold in order to mitigate system degradation in the VM based on page fault occurrences.

In yet another embodiment, specifying requisite access to physical memory allocated to the VM, in a configuration file, wherein the configuration file includes a page fault threshold of the VM can be included. In another embodiment, the method can include monitoring page faults based on a pre-specified threshold level.

In another embodiment of the invention, a virtualization data processing system can be provided. The system can include a hypervisor configured for execution in a host computing platform, a VM image managed by the hypervisor, and, system degradation mitigation logic coupled to the hypervisor, the logic comprising program code enabled to count page fault occurrences in a guest operating system (OS) running in the VM, pin additional physical memory to the VM and initiate a hot-add event to the guest OS running in the VM responsive to exceeding a page fault allowance threshold.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a virtualization data processing system configured to monitor and manage memory used by a hypervisor;

FIG. 2 is a schematic illustration of a virtualization data processing system configured to monitor and manage memory used by a hypervisor; and

FIG. 3 is a flow chart illustrating a process for monitoring and managing memory used by a hypervisor.

### DETAILED DESCRIPTION OF THE INVENTION

Embodiments of the present invention provide a method, system and computer program product for monitoring and managing memory used in a virtual machine environment. In accordance with an embodiment of the present invention, the number of page fault occurrences in a guest OS running in a VM can be counted. Responsive to the counted page faults exceeding a page fault threshold, additional physical memory can be pinned to the VM. Thereafter, a hot-add event can be initiated to the guest OS executing in the VM controlled by a hypervisor.

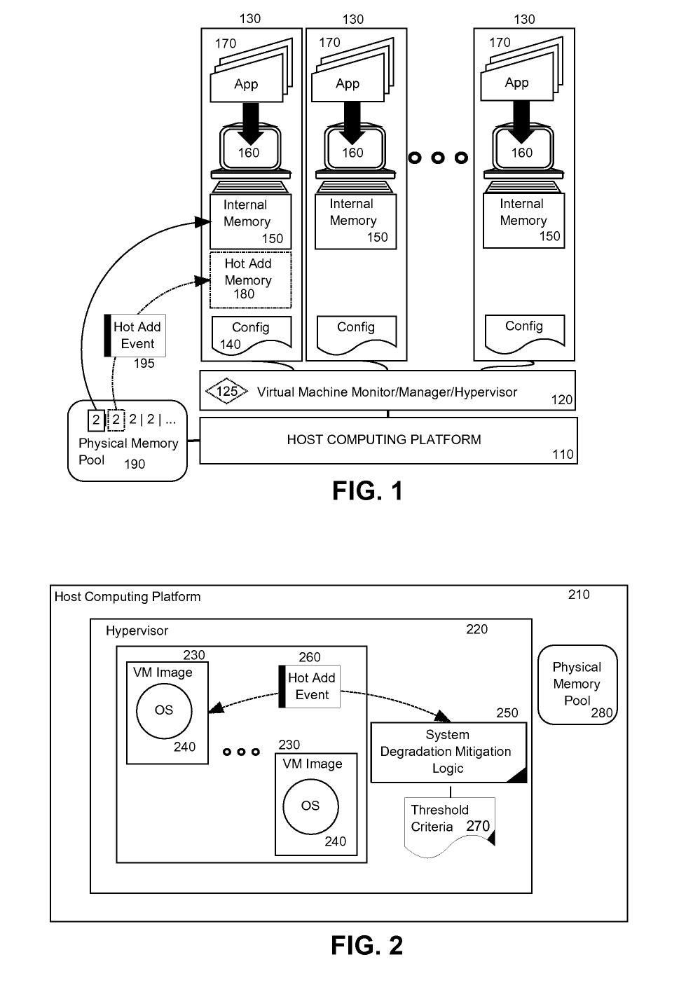

FIG. 1 is a pictorial illustration of a virtualization data processing system configured to monitor and manage memory used by a hypervisor. As shown in FIG. 1, a host computing platform 110 can support the operation of a virtual machine monitor, also known as a hypervisor 120, managing multiple different VM images 130. Each of the VM images 130 can provide a computing environment, including a guest operating system 160, for one or more corresponding applications 170. As such, the hypervisor 120 can establish a configuration 140 for each different one of the VM images 130 specifying requisite access to computing resources provided by the host computing platform 110, for instance processor, physical memory pool 190, file system, communications and even other ones of the VM images 160. The requisite access specified in each configuration 140 can support the intended amount of internal memory 150 in each VM image 130.

Initially, a VM image 160 can be configured to use internal memory 150 linked to the physical memory pool 190 of the host computing platform. The hypervisor 120 can be configured to monitor the VM and count a number of page fault occurrences in a guest OS 160 executing in the VM 130. Thereafter, based on detecting a threshold count of page fault occurrences, the hypervisor 120 can be configured to mitigate system degradation. In order to mitigate system degradation, the hypervisor 120 can be configured to pin additional physical memory 190 to the VM once the page fault threshold 125 has been exceeded, and initiate a hot-add event 195, providing an on-demand increase in virtual memory 180. A hot-add event notifies the guest OS 160 that a memory module is about to be added and the guest OS 160 can remap data in the memory module prior to the addition of physical memory. Since the hot-added virtual memory 180 allocated to the VM 130 is pinned to physical memory 190, the page faulting will eventually abate the system degradation.

In further illustration, FIG. 2 is a schematic illustration of a virtualization data processing system configured to monitor and manage memory used by a hypervisor. The system can include a host computing platform 210 coupled to a hypervisor 220. Furthermore, the system can also include a physical memory pool 280 coupled to the host computing platform 210. The hypervisor 220 can be configured to manage one or more VM images 230. A VM image 230 can notably include a guest OS 240, application instances, middleware, and/or an application server within the VM image. The guest OS 240 inside of the VM 230 can be encapsulated in a virtual environment. The hypervisor 220 is the layer between the VMs 230 and the physical hardware to maintain safe and transparent interactions between the VMs and the physical hardware. Notably, each VM session can be a separate entity that is isolated from other VMs by the hypervisor. If one VM crashes or otherwise becomes unstable, the other VMs, as well as the hypervisor, should not be adversely affected. Thus, the guest OS 240 can lack any awareness of the surrounding physical resources and even the hypervisor 220.

The system can further include system degradation mitigation logic 250 coupled to the hypervisor 220. The system degradation mitigation logic 250 can include program code enabled to monitor VM images 230 for page fault system degradation based on the currently allocated resources of the VM images 230. Furthermore, the system degradation mitigation logic can be enabled to count a number of page fault occurrences in a guest OS 240 running in a VM, and determine whether the page fault threshold has been exceeded. If the number of page faults exceeds the page fault threshold, the system degradation mitigation logic 250 can be enabled to pin more physical memory from the physical memory pool 280 to the VM image 230 and initiate a hot-add event 260 based on exceeding the page fault threshold.

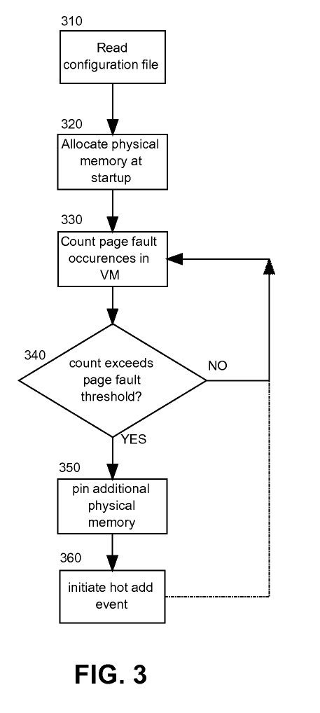

In yet further illustration, FIG. 3 is a flow chart illustrating a process for monitoring and managing memory used by a hypervisor. The process can begin in block 310 in which a configuration file from a VM can be read. The configuration file can specify requisite access to computing resources, such as initial physical memory allocated to the VM at startup, provided by the host computing platform. Additionally, the configuration file can specify a page fault threshold for a VM image. In block 320, physical memory can be allocated to the VM as designated in the configuration file. In block 330 the VM image can be monitored and the number of page fault occurrences in the VM image can be counted. Notably, monitoring page faults to a threshold level can be a matter of policy, including determining what threshold level to specify for a VM image.

In decision block 340, if the page fault count is greater than the page fault threshold, additional physical memory can be pinned from the host computing platform's physical memory pool to the VM in block 350. Thereafter, a hot-add event can be initiated to the OS inside the VM in block 360. Hot-add memory allows ranges of physical memory to be added to a running operating system without requiring the system to be shut down.

Notably, it should be recognized by one skilled in the art that the process of removing memory can be implemented based on low page fault occurrences. For example, a low water mark where paging is significantly low from the guest OS that the hypervisor via a policy definition can be enabled to initiate a removal of memory from the guest OS' internal usage. In other words, the hypervisor can initiate a hot remove event triggered to the guest OS running in the VM and subsequently deallocate corresponding physical memory back to the physical memory pool of the host computing platform.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

1. A method for monitoring and managing memory used by a virtual machine (VM) in a virtualized computing environment in order to mitigate system degradation based on page fault occurrences comprising:
counting page fault occurrences in a guest operating system (OS) executing in the VM;
responsive to the counted page fault occurrences exceeding a page fault allowance threshold, pinning additional physical memory to the VM and initiating a hot-add event to the guest OS, executing in the VM controlled by a hypervisor.

2. The method of claim 1 further comprising specifying requisite access to physical memory allocated to the VM, in a configuration file, wherein the configuration file includes a page fault threshold of the VM.

3. The method of claim 1, further comprising monitoring page faults based on a pre-specified threshold level.

4. A virtualization data processing system comprising:
a hypervisor configured for execution in a host computing platform;
a virtual machine (VM) image managed by the hypervisor; and,
system degradation mitigation logic coupled to the hypervisor, the logic comprising program code enabled to count page fault occurrences in a guest operating system (OS) executing in a VM, to pin additional physical memory to the VM and initiate a hot-add event to the guest OS executing in the VM, controlled by the hypervisor, upon the page fault occurrences exceeding a page fault allowance threshold.

5. A computer program product for monitoring and managing memory used by a virtual machine (VM) in a virtualized computing environment in order to mitigate system degradation based on page fault occurrences, the computer program product comprising a computer usable medium having computer usable code embodied therewith, the computer usable code comprising:
computer usable program code for counting page fault occurrences in a guest operating system (OS) running in the VM;
computer usable program code for pinning additional physical memory to the VM and initiating a hot-add event to the guest OS, upon the counted page fault occurrences exceeding a page fault allowance threshold, executing in the VM controlled by a hypervisor.

6. The computer program product of claim 5 further comprising computer useable program code for specifying requisite access to physical memory allocated to the VM, in a configuration file having a page fault threshold of the VM

7. The computer program product of claim 5 further comprising computer usable program code for monitoring page faults based on a pre-specified threshold level
